(19) United States
(12) Patent Application Publication
(10) Pub. No.: US 2008/0202360 A1
(43) Pub. Date: Aug. 28, 2008

(54) Imprinting Apparatus For Forming Pattern at Uniform Contact by Additional Constant Pressure

(75) Inventor: Jae-Jong Lee, Daejeon (KR)

Correspondence Address: SHERIDAN ROSS PC, 1560 BROADWAY, SUITE 1200, DENVER, CO, 80202, US

(73) Assignee: KOREA INSTITUTE OF MACHINERY & MATERIALS, Daejeon (KR)

(21) Appl. No.: 11/917,102

(22) PCT Filed: Jun. 12, 2006
(86) PCT No.: PCT/KR2006/002230

§ 371 Date: May 9, 2008

(30) Foreign Application Priority Data
Jun. 13, 2005 (KR) 10-2005-0050328

(51) Int. Cl. B44B 5/00

(52) U.S. Cl. 101/3.1

(57) ABSTRACT

The present invention provides an imprinting apparatus (1) in which an expanded tube (43) supports a rear surface of an object substance (W) when a pattern of a mold (21) is imprinted on the object substance. Furthermore, in the present invention, when the tube (43) is expanded to support the object substance, the object substance is supported by the tube by contact first with a portion corresponding to the center of the surface to be imprinted and then with an outside portion thereof, so that the entire pattern of the mold is tightly pressed onto the imprinting surface of the object substance. Thus, the pattern is evenly imprinted on the object substance at constant pressure.

### TECHNICAL FIELD

The present invention relates, in general, to imprinting apparatuses which form patterns on object imprinting substances, such as wafers or substrates, and, more particularly, to an imprinting apparatus in which an expanded tube supports the rear surface of an object substance when a pattern of a mold is imprinted onto the object substance, and in which, when the tube is expanded to support the object substance, expansion thereof begins from a portion corresponding to the central portion of the pattern, thus compressing the object imprinting substance such that the pattern is brought into close contact with the object imprinting substance, thereby evenly imprinting the pattern on the object substance at uniform contact by additional constant pressure.

### BACKGROUND ART

Generally, imprinting apparatus form patterns, such as high density integrate circuits, on upper surfaces of semiconductor wafers or substrates. That is, molds, which are set upped in imprinting heads of the imprinting apparatuses, compress photosensitive emulsions, which have been previously coated on the upper surfaces of object substances, so that the patterns of the molds are imprinted on the object substances.

In methods of forming patterns on object substances using the imprinting apparatuses, there is a method of consecutively imprinting patterns of small molds on the surface of an object substance in a pattern transferring manner, and a method of imprinting patterns of a large mold on the surface of an object substance by means of a single process.

However, in these pattern forming methods, because the object substance is placed on the wafer chuck, the quality of the pattern imprinted on the object substance is greatly influenced by the surface uniformity of the wafer chuck.

In other words, if the wafer chuck is relatively rough, it is difficult to do uniform contact and to get rid of any entrapped air between the molds and the object substance by such that protruding shapes of wafer chuck. Thus, when the pattern of the mold is imprinted on the object substance, the object substance becomes deformed, so that the pattern may not be accurately imprinted on the object substance.

Furthermore, if the wafer chuck has contour, when a pattern is imprinted on the object substance, wedges may occur on the pattern, or, due to the uneven surface of the wafer chuck, a moire pattern may be induced on the object substance, thus causing defective products.

Recently, to avoid such uneven contact, a method in which the surface of the chuck on which the object substance is placed is made vacuous, and fluid is applied to the object substance such that the pattern closely contacts the object substance, has been proposed. However, in this case, fluid may leak outside, so that it is very difficult to accurately form the pattern on the object substance.

### DISCLOSURE OF INVENTION

### Technical Problem

Accordingly, the present invention has been made keeping in mind the above problems occurring in the prior art, and an object of the present invention is to provide an imprinting apparatus in which an expanded tube supports the rear surface of an object substance when the pattern of a mold is imprinted onto the object substance, and in which, when the tube is expanded to support the object substance, the object substance is supported by the tube by contact therewith, first at a portion corresponding to the center of the surface to be imprinted, and then at an outside portion thereof, so that the mold is tightly and uniformly pressed onto the imprinting surface of the object substance, thus evenly imprinting the pattern on the object substance at uniform contact by additional constant pressure.

### Technical Solution

In order to accomplish the above object, the present invention provides an imprinting apparatus for forming a pattern at uniform contact by an additional constant pressure, comprising: an imprinting head including a mold, which has a pattern and is coupled to a flexible hinge spring; and a wafer chuck disposed at a position facing the imprinting head and allowing an object imprinting substance to be seated onto an upper surface thereof, so that the pattern of the mold is formed on the object imprinting substance by moving the imprinting head or the wafer chuck. A support device, which defines therein a support chamber and includes a tube 43 that is placed in the support chamber and is expanded or returned to an initial state thereof depending on supply of fluid into the tube, is mounted on the wafer chuck, so that, when the pattern of the mold is formed on a surface of the object imprinting substance, fluid is supplied into the tube, thus expanding the tube such that the expanded tube contacts and supports a rear surface of the object imprinting substance opposite the surface on which the pattern is formed.

Preferably, the support device may include a base plate having a receiving space therein and provided on the chuck; a support frame placed in the receiving space of the base plate and having therein at least one support chamber, in which the tube is placed such that, when the tube is expanded, the tube supports the object imprinting substance, the support frame having a fluid discharge passage formed at an open end of the support chamber to discharge fluid from the support chamber to an outside while the tube is expanded; the tube disposed in the support chamber and expanded or returned to the initial state thereof depending on whether fluid is supplied, the tube supporting the object imprinting substance when being expanded; and a fluid controller connected to the tube to supply the fluid into the tube.

Preferably, the tube may be made of an elastic membrane.

### Advantageous Effects

In the present invention having the above-mentioned construction, a tube, which is expanded by the fluid supply operation of a fluid controller, supports the rear surface of an object imprinting substance at a position corresponding to a pattern of a mold. At this time, the tube supports the object substance by first contacting it at a portion corresponding to the center of the pattern and then at an outside portion thereof, so that the pattern of the mold is brought into close contact with the surface of the object substance, thus being evenly imprinted on the object substance.

Therefore, the present invention solves the disadvantage of the conventional art, in which the pattern is unevenly imprinted on the surface of the object substance due to contour shapes formed at the junction between the pattern and the surface of the object substance, thus reducing the number of defective products.

### BRIEF DESCRIPTION OF THE DRAWINGS

FIG. 1 is a side sectional view showing an imprinting apparatus to illustrate the state just before formation of a pattern on a wafer, according to an embodiment of the present invention;

FIG. 2 is a perspective view of a support frame of the imprinting apparatus of FIG. 1;

FIG. 3 is a side sectional view showing an initial stage of a process in which tubes support the wafer according to the present invention;

FIG. 4 is a side sectional view showing the tubes which securely support the wafer according to the present invention; and

FIG. 5 is a plan view showing the state of the tubes when a support device is supporting the wafer according to the present invention.

### Best Mode for Carrying Out the Invention

Hereinafter, the construction of an imprinting apparatus having a function of forming a pattern at constant pressure according to an embodiment of the present invention will be described in detail with reference to the attached drawings.

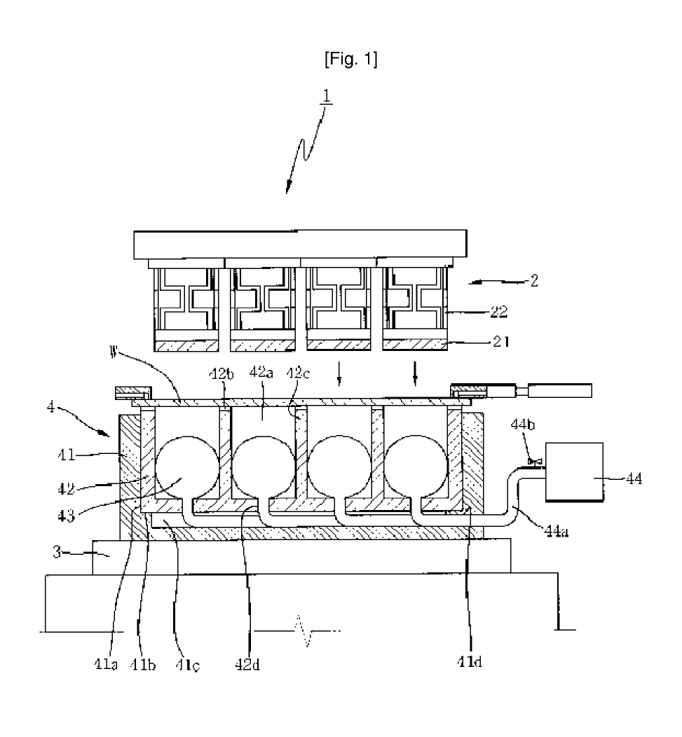

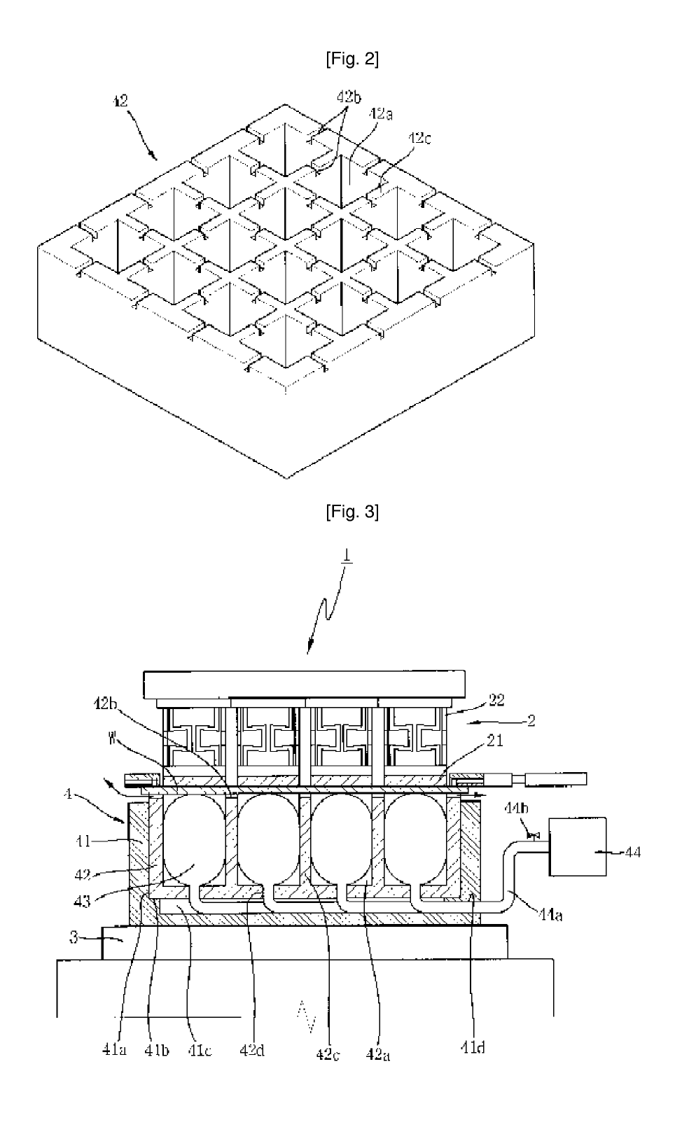

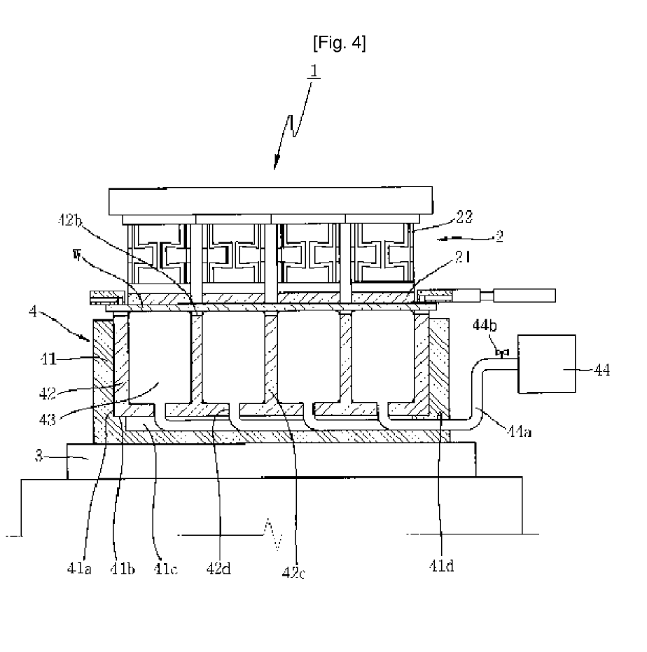

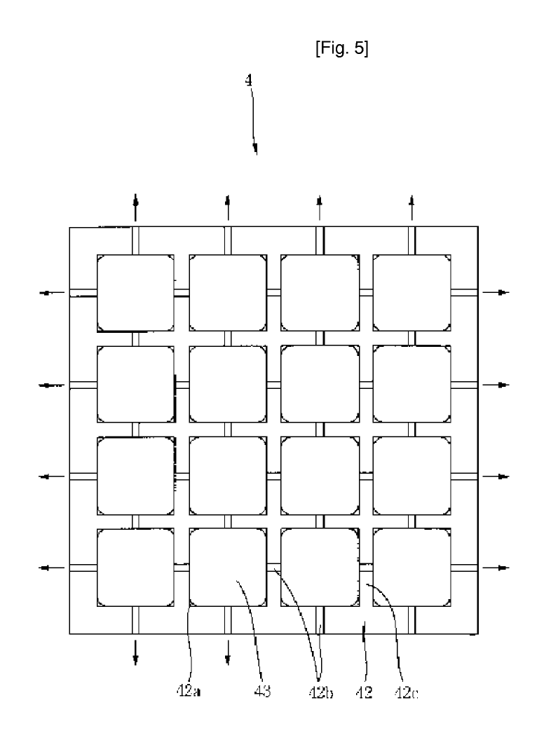

FIG. 1 is a side sectional view showing an imprinting apparatus 1 to illustrate the state just before formation of a pattern on a wafer, according to the present invention. FIG. 2 is a perspective view of a support frame of the imprinting apparatus 1. FIG. 3 is a side sectional view showing the initial stage of a process in which tubes support the wafer. FIG. 4 is a side sectional view showing the tubes 43 which securely support the wafer. FIG. 5 is a plan view showing the state of the tubes 43 when a support device 4 is supporting the wafer.

As shown in the drawings, the imprinting apparatus 1 of the present invention includes an imprinting head 2, which has a plurality of molds 21, each of which has a pattern and is coupled to each flexible hinge spring 22, like the conventional imprinting apparatus. The imprinting apparatus 1 further includes a wafer chuck 3, which is disposed at a position facing the imprinting head 2, and onto which an object imprinting substance W is seated. Thus, the patterns of the molds are formed on the object imprinting substance W by moving the imprinting head 2 or the wafer chuck 3.

In the imprinting apparatus 1 of the prevent invention for forming a pattern at a constant pressure, the support device 4, which defines therein a plurality of support chambers 42a and includes a plurality of tubes 43 that are placed in each support chamber 42a so that the tubes 43 are expanded or returned to the initial state thereof depending on the supply of fluid into the tubes 43, is mounted on the wafer chuck 3. When the patterns of the molds 21 are formed on the surface of the object imprinting substance W, fluid is supplied to the tubes 43 to expand the tubes 43. Thus, the expanded tubes 43 contact and support the rear surface of the object imprinting substance W opposite the surface on which the pattern is formed.

In this embodiment of the present invention, the several molds 21 are provided, so that the support device 4 has a number of tubes 43 corresponding to the number of molds. Each tube 43 is expanded to an area greater than the area of the corresponding pattern, so that it supports the entire area of the pattern such that the patterns are evenly imprinted on the object imprinting substance W.

The support device 4 includes a base plate 41, a support frame 42, which is placed in a receiving space 41a, and the tubes 43, which are placed in the support frame 42 and are expanded or returned to initial states thereof depending on the supply of fluid into the tubes 43, so that, when the tubes 43 are expanded, they support the object imprinting substance W for imprinting patterns. The support device 4 further includes a hydraulic controller 44, which is connected to the tubes 43 to supply fluid into the tubes 43.

The base plate 41 is mounted on the wafer chuck 3 and has a receiving space therein so that the support frame 42 is placed in the receiving space. Here, the base plate 41 is mounted on the wafer chuck 3 by a well-known coupling method, such as force-fitting, welding or bonding. Because such a method is well-known, a detailed description thereof is not shown in the drawings.

The base plate 41 includes a support stop 41b, which is provided at a lower position in the receiving space 41a and supports the support frame 42, and a space 41c, which is defined inside and below the support stop 41b so that a supply pipe 44a, through which fluid is supplied into the tubes 43, is placed in the space 41c. A guide hole 41d is formed at a predetermined position through a sidewall, which defines the space 41c, so that the supply pipe 44a passes through the guide hole 41d.

The support frame 42 is placed in the receiving space 41a of the base plate 41 and has a plurality of support chambers 42a, each of which has one tube 43 therein and is open at one end thereof such that, when the tubes 43 are expanded, the tubes 43 support the object imprinting substance W. Furthermore, a plurality of fluid discharge passages 42b is formed in the open end of the walls defining the support chambers 42a, so that, when the tubes 43 are expanded, fluid, which has been in the support chambers 42a, is discharged through the fluid discharge passages 42b.

In this embodiment, several support chambers 42a are defined in the support frame 42. For this, as shown in the drawings, partition walls 42c are provided in a lattice arrangement. The support chambers 42a are defined between the partition walls 42c, and the fluid discharge passages 42b are formed in the open end of the partition walls 42c.

Furthermore, a through hole 42d is formed through the bottom of each support chamber 42a, so that the supply pipe 44a which supplies the tube 43 passes through the through hole 42d.

Each tube 43 is placed in a support chamber 42a of the support frame 42. When fluid is supplied into the tubes 43, the tubes 43 are expanded, thus supporting the object imprinting substance W. The tubes 43 are expanded or returned to the initial state thereof depending on whether fluid is supplied. Furthermore, the tubes 43 must be made of elastic material such that the expanded tubes 43 can support the object imprinting substance W when patterns of the molds 21 are imprinted on the object imprinting substance W. Each tube 43 must be made of material which is watertight, in order to prevent supplied fluid from leaking. Preferably, the tube 43 is made of an elastic membrane.

The fluid controller 44 controls the supply of fluid into the tubes 43 and includes a device, which forcibly supplies fluid into the tubes 43, that is, a compressor (not shown). An outlet of the fluid controller 44 is coupled to the supply pipe 44a, which is connected to the tubes 43. Furthermore, a control valve 44b, which controls a fluid path, is provided at the outlet of the fluid controller 44, so that, when the process of imprinting patterns on an object imprinting substance W is not conducted, the control valve 44b discharges fluid, which has been charged into the tubes 43. When the tubes 43 support the object imprinting substance W, the control valve 44b closes the outlet of the fluid controller 44.

The fluid controller 44 having the above-mentioned construction is a well known technique for controlling the flow of fluid.

The operation of the imprinting apparatus, that is, a process of forming patterns of the molds 21 on the object imprinting substance, will be explained herein below.

As shown in FIG. 1, the support device 4 of the present invention is mounted on the wafer chuck 3. Thereafter, the object imprinting substance W is placed on and fastened to the support frame 42 using a holding means.

In this state, the imprinting head 2 descends so that the patterns of the molds 21, which are disposed at lower positions in the imprinting head 2, compress the surface of the object imprinting substance W, thereby the patterns of the molds 21 are imprinted in photosensitive emulsion, which was previously applied to the surface of the object imprinting substance W. At this time, the fluid controller 44 operates the compressor to supply fluid into the tubes through the supply pipe 44a so as to expand the tubes 43.

As shown in FIG. 4, when the patterns of the mold 21 are formed on the object imprinting substance W, the convex part of each of the tubes 43, expanded by the fluid controller 44, comes into contact with the portion of the rear surface of the object imprinting substance W opposite the portion on which each pattern is to be formed, thus the tubes 43 begin to support the object imprinting substance W.

As such, when the tubes 43 are expanded, fluid, which has been in the support chambers 42a, must be discharged outside due to the increased volume of the tubes 43. For this, the support chambers 42a communicate with the outside through the fluid discharge passages 42b, which are formed in the upper ends of the partition walls 42c. Therefore, the fluid is smoothly discharged outside through the fluid discharge passages 42b.

Fluid is continuously supplied to the tubes 43, so that the tubes 43 completely occupy the support chambers 42a and so that the upper ends of the tubes 43 are in close contact with the rear surface of the object imprinting substance W, as shown in FIG. 5.

Therefore, the patterns of the molds 21 can be evenly formed on the object imprinting substance W to constant thickness thanks to the support of the tubes 43.

Preferably, in the process of forming patterns on the object imprinting substance W, among the tubes arranged in a lattice arrangement, tubes disposed in the central portion are first expanded and, thereafter, tubes, which are disposed at positions increasingly spaced apart from the center tubes, are consecutively expanded.

As such, when the tubes are consecutively expanded starting with the tubes disposed in the central portion and then moving to the tubes disposed at the edges, the object imprinting substance can be evenly supported by the tubes. Therefore, the patterns of the molds 21 can be evenly formed on the object imprinting substance W to a constant thickness thanks to the support of the tubes 43.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. An imprinting apparatus for forming a pattern at uniform contact by the additional constant pressure, comprising: an imprinting head including a mold, which has a pattern and is coupled to a flexible hinge spring; and a wafer chuck disposed at a position facing the imprinting head and allowing an object imprinting substance to be seated onto an upper surface thereof, so that the pattern of the mold is formed on the object imprinting substance by moving the imprinting head or the wafer chuck, wherein a support device, which defines therein a support chamber and includes a tube that is placed in the support chamber and is expanded or returned to an initial state thereof depending on supply of fluid into the tube, is mounted on the wafer chuck, so that, when the pattern of the mold is formed on a surface of the object imprinting substance, fluid is supplied into the tube, thus expanding the tube such that the expanded tube contacts and supports a rear surface of the object imprinting substance opposite the surface on which the pattern is formed.

2. The imprinting apparatus according to claim 1, wherein the support device comprises: a base plate having a receiving space therein and provided on the chuck; a support frame placed in the receiving space of the base plate and having therein at least one support chamber, in which the tube is placed such that, when the tube is expanded, the tube supports the object imprinting substance, the support frame having a fluid discharge passage formed at an open end of the support chamber to discharge fluid from the support chamber to an outside while the tube is expanded; the tube disposed in the support chamber and expanded or returned to the initial state thereof depending on whether fluid is supplied, the tube supporting the object imprinting substance when being expanded; and a fluid controller connected to the tube to supply the fluid into the tube.

3. The imprinting apparatus according to claim 2, wherein the tube is made of an elastic membrane.
